(19) United States
(12) Patent Application Publication
(10) Pub. No.: US 2026/0081251 A1
(43) Pub. Date: Mar. 19, 2026

(54) THERMAL MANAGEMENT DEVICE, BATTERY MODULE, AND ELECTRIC EQUIPMENT

(71) Applicant: EVE ENERGY CO., LTD., Huizhou (CN)

(72) Inventors: Jieyu ZHOU, Huizhou (CN); Liesong WU, Huizhou (CN); Xiaokang LI, Huizhou (CN); Zhimiao LI, Huizhou (CN); Dongrong QI, Huizhou (CN)

(73) Assignee: EVE ENERGY CO., LTD., Huizhou (CN)

(21) Appl. No.: 19/399,511

(22) Filed: Nov. 24, 2025

Related U.S. Application Data
(63) Continuation of application No. PCT/CN2024/131262, filed on Nov. 11, 2024.

(30) Foreign Application Priority Data
Jul. 30, 2024 (CN) 202421834667.7

(51) Int. Cl. H01M 10/637; H01M 10/615; H01M 10/643; H01M 10/659; H01M 50/213; H01M 50/291; H01M 50/503

(52) U.S. Cl. CPC H01M 10/637; H01M 10/615; H01M 10/643; H01M 10/659; H01M 50/213; H01M 50/291; H01M 50/503

(57) ABSTRACT

The present disclosure provides a thermal management device, a battery module, and an electric equipment. The thermal management device includes a thermal conductor configured to be in contact with a battery; and a heater including a heat generating portion embedded in the thermal conductor.

### CROSS-REFERENCE TO RELATED APPLICATIONS

This application is a continuation application of International Application No. PCT/CN2024/131262, filed on Nov. 11, 2024, which claims priority to Chinese Patent Application No. 202421834667.7, filed on Jul. 30, 2024 to China National Intellectual Property Administration, both of which are incorporated herein by reference in its entirety.

### TECHNICAL FIELD

The present disclosure relates to the field of battery technologies, and in particular to a thermal management device, a battery module, and an electric equipment.

### BACKGROUND

Lithium batteries are highly sensitive to ambient temperature. High temperature, low temperature, or uneven temperature all cause fatal influence to the lithium batteries. Therefore, thermal management systems are commonly employed in lithium battery systems to regulate the temperature of the lithium batteries.

In related technologies, a typical thermal management method for batteries involves the use of serpentine water-cooling plates for cooling, heating, and enhancing temperature uniformity. The effect of this type of thermal management method is remarkable.

### SUMMARY

However, this type of thermal management method requires a large amount of space and heavy weight, making it difficult to apply to lithium batteries with limited space and weight, such as those used in electric tools and electric two-wheeled vehicles.

The present disclosure provides a thermal management device including: a thermal conductor configured to be in contact with a battery; and a heater including a heat generating portion embedded in the thermal conductor.

The present disclosure further provides a battery module including: two or more batteries; and one or more the aforementioned thermal management devices, where each of the one or more thermal management devices includes: a thermal conductor configured to be in contact with a battery, adjacent to the thermal conductor, of the two or more batteries, adjacent to the thermal conductor, of the two or more batteries; and a heater including a heat generating portion embedded in the thermal conductor.

The present disclosure further provides an electric equipment including the aforementioned battery module.

### BRIEF DESCRIPTION OF THE DRAWINGS

FIG. 1 to FIG. 3 are schematic diagrams of a structure of a thermal management device according to embodiments of the present disclosure.

FIG. 4 is a schematic diagram of a structure of a battery module according to embodiments of the present disclosure, with a part of a first fixing member shown.

FIG. 5 to FIG. 7 are top views of the battery module according to embodiments of the present disclosure, with the first fixing member and the thermal management device not shown.

### DETAILED DESCRIPTION

In the description of the present disclosure, unless otherwise explicitly defined or limited, terms such as “connected,” “attached,” or “fixed” are to be interpreted in a broad way, including fixed or detachable connections, integrated structures, mechanical or electrical connections, direct or indirect connections via intermediate media, or internal communication between two components or an interactive relationship between two components. Persons skilled in the art may construe the specific meanings of these terms in the present disclosure as appropriate.

In the description of the present embodiment, the terms “upper,” “lower,” “left,” “right,” “front,” “rear,” and the like refer to directions or positional relationships based on those shown in the accompanying drawings. They are used merely for the sake of convenience in description and simplification of the explanation and are not intended to indicate or imply that the referenced devices or components must have a particular orientation or be constructed and operated in a particular manner. Therefore, they should not be construed as limiting the present disclosure. In addition, the terms “first,” “second,” and the like are used solely to distinguish one element from another and carry no special meaning.

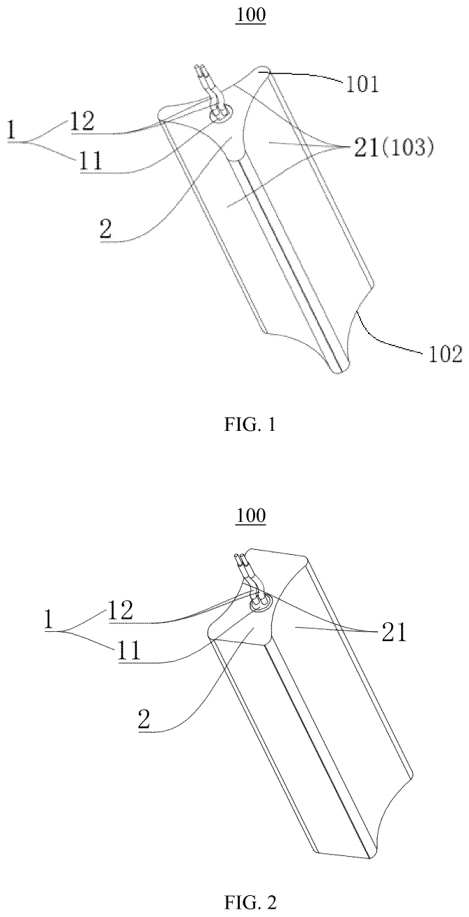

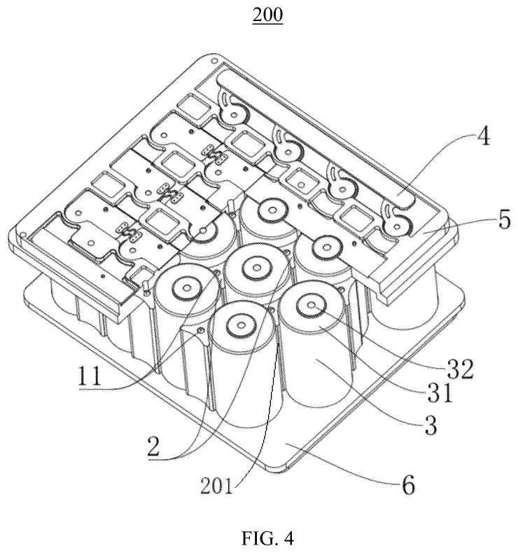

With reference to FIG. 1 to FIG. 3, according to a first aspect, embodiments of the present disclosure provide a thermal management device 100 including:
a thermal conductor 2 including a top surface 101, a bottom surface 102 disposed opposite to the top surface 101, and a side surface 103 extending between the top surface 101 and the bottom surface 102, the thermal conductor 2 configured to be in contact with a battery. In an embodiment, the thermal conductor 2 is configured to fill a gap 201 (as shown in FIG. 4) formed among batteries 3 (as shown in FIG. 4) adjacent to the thermal conductor; and
a heater 1 including a heat generating portion 11 embedded in the thermal conductor 2.

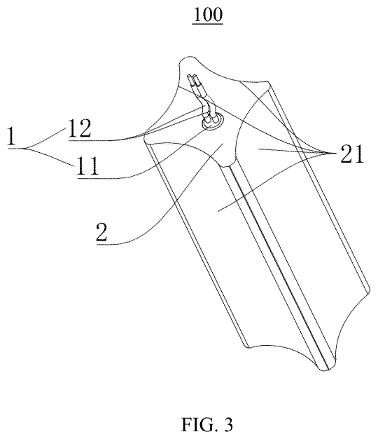

It can be understood that the side surface 103 is in contact with circumferential surfaces of the batteries surrounding the thermal management device. In one embodiment, as shown in FIG. 2, the side surface 103 includes two arc surfaces 21, each of the two arc surfaces 21 matches a circumferential surface of a battery adjacent to the corresponding arc surface. In another embodiment, as shown in FIG. 1, the side surface 103 includes three arc surfaces 21, each of the three arc surfaces 21 matches a circumferential surface of a battery adjacent to the corresponding arc surface. In yet another embodiment, as shown in FIG. 3, the side surface 103 includes four arc surfaces 21, each of the four arc surfaces 21 matches a circumferential surface of a battery adjacent to the corresponding arc surface.

It is understood that the heater 1 is arranged in the thermal conductor 2 to enable direct contact between a heating source and the thermal conductor 2, thereby improving heat transfer efficiency. The thermal conductor 2 is arranged in the gaps between the batteries 3, so that the space between batteries 3 is effectively utilized, which is conducive to reducing the overall space occupied by the battery module and improving thermal management efficiency. The batteries 3 may be cylindrical, prismatic, or of other shapes. The batteries 3 arranged in an array are in contact with each other or spaced apart from each other by a certain distance. To improve the compactness of the overall structure of the battery module, the batteries 3 arranged in an array in this embodiment are arranged close to one another. The thermal conductor 2 is made of materials with thermal conductivity. The shape of the thermal conductor 2 can be configured as needed. The thermal conductor 2 fills the entire gap or a part of the gap, which is configured depending on the thermal management requirements. It should be noted that the filling of the entire gap or a part of the gap is referred to an axial direction of the batteries 3. The filling of the entire gap through the thermal conductor 2 is referred to a dimension of the thermal conductor 2 along the axial direction of the batteries 3 is equal to an axial length of the batteries 3. Accordingly, the filling of a part of the gap through the thermal conductor 2 is referred to the dimension of the thermal conductor 2 along the axial direction of the batteries 3 is less than the axial length of the batteries 3. The dimension of the thermal conductor 2 along the axial direction of the batteries 3 is configured depending on the thermal management requirements. For a dimension of the thermal conductor 2 along a radial direction of the batteries 3, it is advisable to make the thermal conductor 2 in contact with the surrounding batteries 3 or even the thermal conductor 2 matches circumferential surfaces of the surrounding batteries 3 in shape. The thermal conductor 2 is fixed by clamping between the surrounding batteries 3 for easy installation. The heater 1 is a device capable of generating heat, and the heat generating portion 11 is a component configured for generating heat of the heater 1. The heat generating portion 11 is embedded in the thermal conductor 2, so that the heater 1 is fixed by being embedded in the thermal conductor 2. Alternatively, a mounting hole 111 is formed along an axial direction of the thermal conductor 2, and the heat generating portion 11 is inserted into the mounting hole. The mounting hole is a through hole or a blind hole. In a case that the battery module is placed in an external environment at a low temperature and needs to be heated, the heater 1 is turned on to heat the batteries 3 through heat transfer from the thermal conductor 2 to the batteries 3.

In one embodiment, the heater 1 is a PTC heating rod, and a heat generating portion 11 of the heating rod is extended along the axial direction of the batteries 3. Since the axial dimension of the batteries 3 is typically greater than the radial dimension of the batteries, the heat generating portion 11 is extended along the axial dimension of the batteries 3, which facilitates to improve heating efficiency. To further improve heating efficiency, the heat generating portion 11 is extended from one end of the thermal conductor 2 to the other end of the thermal conductor 2.

It can be understood that the PTC heating rod exhibits a constant temperature heating characteristic. The working principle of the PTC heating rod is that: a PTC thermistor heats up by itself when being powered on and its temperature rises, causing its resistance to get into a transition region. The surface temperature of the PTC thermistor remains constant, and the temperature is only dependent on the Curie temperature of the thermistor and the applied voltage, and is almost independent of the ambient temperature, thereby improving thermal management efficiency. The specific values of the diameter and length of the heating rod is configured based on the size of the thermal conductor 2, the dimension of the gap, and thermal management requirements.

In one embodiment, the heat generating portion 11 is arranged at a central axis of the gap. The arrangement of the heat generating portion 11 at a central axis of the gap facilitates to uniformly heat the surrounding batteries through the heat generating portion 11, thereby enhancing temperature uniformity.

It can be understood that the heat generating portion 11 is arranged at the central axis of the gap, so that the uniformity of heat conduction from the thermal conductor 2 to the surrounding batteries is improved, thereby improving thermal management efficiency.

In another embodiment, surfaces, away from the heat generating portion 11, of the thermal conductor 2 are respectively in contact with circumferential surfaces of the surrounding batteries 3.

It can be understood that the surfaces, away from the heat generating portion 11, of the thermal conductor 2 are respectively in contact with the circumferential surfaces of the surrounding batteries 3, so that the gaps between batteries 3 are effectively utilized, and meanwhile heat transfer efficiency through thermal conductor 2 is enhanced. In some embodiments, each surface, away from the heat generating portion 11, of the thermal conductor 2 is in contact with a part of the circumferential surface of each of the surrounding batteries 3. The circumferential surface of the battery 3 located between adjacent three thermal conductors 2 is surrounded by the three thermal conductors.

In one embodiment, the thermal conductor 2 is a layer made of phase change material.

It can be understood that the thermal conductor 2 is a layer made of phase change material, so that the thermal conductor 2 absorbs or releases a large amount of latent heat during a phase transition process to maintain a substantially constant temperature. In a case that the battery 3 needs to be cooled down due to high temperature, the phase change material effectively absorbs heat and provides a significant temperature uniformity, so that the heat is effectively utilized, and consequently the thermal management efficiency is improved. Phase change material refers to a substance that changes its physical state at a constant temperature and provides latent heat, including both an inorganic phase change material, and an organic phase change material, which can be selected as needed.

According to the thermal management device of this disclosure, the thermal conductor 2 is arranged in the gaps between the batteries 3, so that the space between batteries 3 is effectively utilized, which is conducive to reducing the overall space occupied by the battery module and improving thermal management efficiency.

With reference to FIG. 1 to FIG. 7, according to a second aspect, embodiments of the present disclosure provide a battery module 200, including:
two or more batteries 3; and
one or more aforementioned thermal management device, where each of one or more thermal management devices includes: a thermal conductor configured to be in contact with a battery, adjacent to the thermal conductor, of the two or more batteries; and a heater including a heat generating portion embedded in the thermal conductor.

The adjacent arrangement of the two or more batteries includes various configurations such as linear alignment, grid layout, honeycomb pattern.

It can be understood that the thermal management device are arranged in all gaps formed between the batteries 3, or are arranged in some of the gaps formed between the batteries 3. The number and position of the thermal management device are set according to thermal management requirements. In a case that the thermal management devices are arranged in some of the gaps formed between the batteries 3, the multiple thermal management devices are uniformly distributed to ensure temperature uniformity of the battery module.

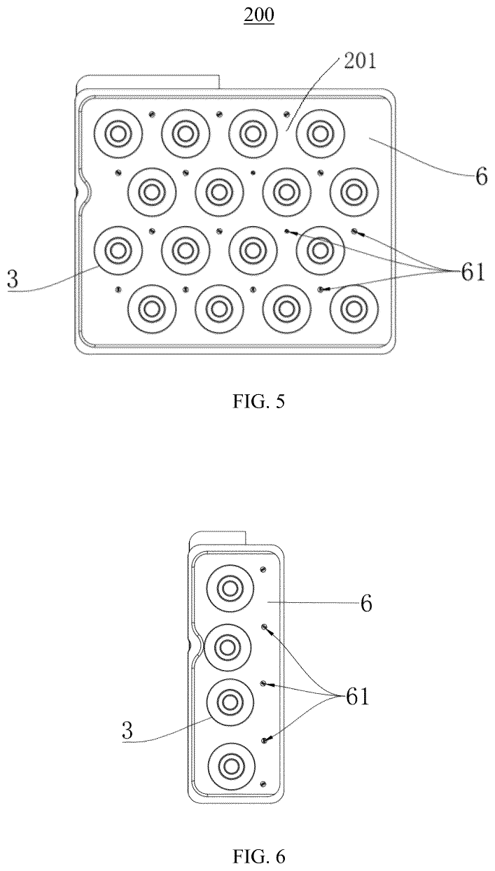

With reference to FIG. 1 and FIG. 5, in one embodiment, the batteries 3 are cylindrical batteries, and multiple batteries 3 are arranged in a triangular array. Adjacent rows of batteries 3 are arranged offset from each other. The side surface of the thermal conductor 2 includes three arc surfaces 21 that are in contact with the circumferential surfaces of the three surrounding batteries 3.

It can be understood that the cylindrical batteries are arranged in a triangular array, so that space utilization is improved, and the overall size of the battery module is reduced. The thermal conductor 2 is arranged to include three arc surfaces 21, so that the space between cylindrical batteries is effectively utilized through the thermal conductor 2, thereby enhancing thermal management efficiency. The three arc surfaces 21 of the thermal conductor 2 are in contact with the circumferential surfaces of the surrounding batteries 3, so that the thermal conductor 2 is stably fixed, and thermal conductivity efficiency is improved.

With reference to FIG. 2 and FIG. 6, in another embodiment, the batteries 3 are cylindrical batteries, and multiple batteries 3 are arranged in a linear array. The side surface of the thermal conductor 2 includes two arc surfaces 21 that are in contact with the circumferential surfaces of the two surrounding batteries 3.

It can be understood that the side surface of the thermal conductor 2 is arranged to include two arc surfaces 21, and matches with the cylindrical batteries that are arranged in a linear array, so that the space between the cylindrical batteries is effectively utilized through the thermal conductor, thereby improving thermal management efficiency. The two arc surfaces 21 of the thermal conductor 2 are in contact with the circumferential surfaces of the surrounding batteries 3, so that the thermal conductor 2 is stably fixed, and thermal conductivity efficiency is improved.

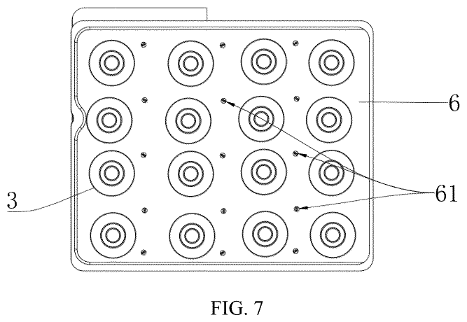

With reference to FIG. 3 and FIG. 7, in yet another embodiment, the batteries 3 are cylindrical batteries, and the multiple batteries 3 are arranged in a grid square array. The side surface of the thermal conductor 2 includes four arc surfaces 21 that shaped to match the circumferential surfaces of the four surrounding batteries 3.

It can be understood that the thermal conductor 2 is arranged to include four arc surfaces 21, and matches with the cylindrical batteries that are arranged in a grid square array, so that the space between the cylindrical batteries is effectively utilized through the thermal conductor 2, thereby improving thermal management efficiency. The four arc surfaces 21 of the thermal conductor 2 are in contact with the circumferential surfaces of the surrounding batteries 3, so that the thermal conductor 2 is stably fixed, and thermal conductivity efficiency is improved.

In one embodiment, multiple gaps are formed by multiple batteries 3, and a thermal management device is arranged in each gap.

It can be understood that a thermal management device is arranged in each gap to enhance thermal management efficiency. A thermal management device is arranged in each gap to allow the circumferential surface of the battery 3 located in the middle completely surrounded by multiple thermal conductors 2, facilitating sufficient heat exchange.

In one embodiment, the battery module further includes a busbar. The heater 1 further includes an output harness 12. The output harness 12 is electrically connected to the heat generating portion 11. The busbar and the output harness 12 are respectively arranged at two axial ends of the batteries 3. Positive terminals 32 of the batteries 3, negative terminals 31 of the batteries 3, and the busbar 4 are arranged on a same axial end of the batteries 3.

It can be understood that the busbar and the output harness are respectively arranged at two axial ends of the batteries to avoid contact between the busbar and the output harness, thereby preventing the output harness from being cut by the busbar and causing short circuits, and meanwhile facilitating the implementation of electrical-thermal separation. The positive and negative terminals of the batteries are arranged on the same end, which also facilitates the implementation of electrical-thermal separation. The output harness 12 transmits electrical energy to the heater 1 to enable the heating function of the heater 1.

In one embodiment, the battery module further includes a first fixing member 5 and a second fixing member 6 arranged opposite to each other. The batteries 3 are fixedly mounted between the first fixing member 5 and the second fixing member 6. The busbar is fixed to the first fixing member 5, and an outlet hole 61 is formed at the second fixing member 6, the output harness 12 passes through the outlet hole 61 to be led out from the second fixing member 6.

It can be understood that an outlet hole 61 is formed at the second fixing member 6 to fix and lead out the output harness 12.

In one embodiment, the first fixing member 5 is an upper fixing clamp plate. The second fixing member 6 is a lower fixing clamp plate.

It can be understood that the upper clamping plate is an insulating plastic plate, and the lower clamping plate is an insulating plastic plate or a sprayed metal plate.

According to a third aspect, the present disclosure provides an electric equipment including the aforementioned battery module.

What is claimed is

1. A thermal management device, comprising:
a thermal conductor configured to be in contact with a battery; and
a heater comprising a heat generating portion embedded in the thermal conductor.

2. The thermal management device according to claim 1, wherein the heater is a PTC heating rod, and a heat generating portion of the heating rod is extended along an axial direction of the battery.

3. The thermal management device according to claim 1, wherein the thermal conductor comprises a top surface, a bottom surface disposed opposite to the top surface, and a side surface extending between the top surface and the bottom surface, and the side surface is in contact with a circumferential surface of the battery.

4. The thermal management device according to claim 3, wherein the side surface comprises two or more arc surfaces, each of the two or more arc surfaces is in contact with the circumferential surface of the battery.

5. The thermal management device according to claim 1, wherein a mounting hole is formed along an axial direction of the thermal conductor, and the mounting hole is configured so that the heat generating portion is inserted into the mounting hole.

6. The thermal management device according to claim 3, wherein the heat generating portion is extended from the top surface of the thermal conductor to the bottom surface of the thermal conductor.

7. The thermal management device according to claim 1, wherein the heater further includes an output harness, and the output harness is electrically connected to the heat generating portion.

8. The thermal management device according to claim 1, wherein the thermal conductor is a layer made of phase change material.

9. A battery module, comprising:
two or more batteries; and
one or more thermal management devices,
wherein each of the one or more thermal management devices comprises:
a thermal conductor configured to be in contact with a battery, adjacent to the thermal conductor, of the two or more batteries; and
a heater comprising a heat generating portion embedded in the thermal conductor.

10. The battery module according to claim 9, wherein each thermal conductor is arranged in a gap enclosed by the batteries, adjacent to the thermal conductor, of the two or more batteries.

11. The battery module according to claim 10, wherein one or more gaps are formed among the two or more batteries, and one thermal conductor is arranged in each of the gaps.

12. The battery module according to claim 11, wherein the heat generating portion is arranged at a central axis of the gaps.

13. The battery module according to claim 9, wherein the thermal conductor comprises a top surface, a bottom surface disposed opposite to the top surface, and a side surface extending between the top surface and the bottom surface, and the side surface is in contact with circumferential surfaces of the batteries, adjacent to the thermal conductor, of the two or more batteries.

14. The battery module according to claim 13, wherein the side surface comprises two or more arc surfaces, each of the two or more arc surfaces is in contact with a circumferential surface of one battery, adjacent to the thermal conductor, of the two or more batteries.

15. The battery module according to claim 14, wherein the two or more arc surfaces are two arc surfaces, three arc surfaces, or four arc surfaces.

16. The battery module according to claim 15, wherein the two or more batteries are cylindrical batteries, the two or more arc surfaces are two arc surfaces, and the batteries, adjacent to the thermal conductor, of the two or more batteries are arranged in a linear array.

17. The battery module according to claim 15, wherein the two or more batteries are cylindrical batteries, the two or more arc surfaces are three arc surfaces, and the batteries, adjacent to the thermal conductor, of the two or more batteries are arranged in a triangle array.

18. The battery module according to claim 15, wherein the two or more batteries are cylindrical batteries, the two or more arc surfaces are four arc surfaces, and the batteries, adjacent to the thermal conductor, of the two or more batteries are arranged in a square array.

19. The battery module according to claim 10, wherein the battery module further comprises a busbar, and the heater further comprises an output harness, the output harness is electrically connected to the heat generating portion; the busbar and the output harness are arranged at two axial ends of the two or more batteries, and positive terminals of the batteries, negative terminals of the two or more batteries, and the busbar are arranged on a same axial end of the two or more batteries.

20. The battery module according to claim 19, wherein the battery module further comprises a first fixing member and a second fixing member arranged opposite to each other, the two or more batteries are fixed between the first fixing member and the second fixing member; the busbar is fixed to the first fixing member, one or more outlet holes are formed at the second fixing member, and the output harness passes through the outlet hole to be led out from the second fixing member.
